(19) United States
(12) Patent Application Publication
(10) Pub. No.: US 2013/0312112 A1
(43) Pub. Date: Nov. 21, 2013

(54) LICENSING PROTECTED WORKS WITHIN ELECTRONIC INFORMATION NETWORKS

(71) Applicant: RUMBLEFISH, INC., Portland, OR (US)

(72) Inventors: PAUL ANTHONY TROIANO, PORTLAND, OR (US); JEFF GODDARD, PORTLAND, OR (US)

(73) Assignee: RUMBLEFISH, INC., PORTLAND, OR (US)

(21) Appl. No.: 13/897,104

(22) Filed: May 17, 2013

Related U.S. Application Data
(60) Provisional application No. 61/648,907, filed on May 18, 2012.

(51) Int. Cl. G06F 21/60

(52) U.S. Cl. CPC G06F 21/60
USPC 726/27

(57) ABSTRACT

License information, including a license identifier (if present) is associated with a protected work that is published within an electronic information network. The license information indicates a purported license to publish the protected work. The license information may be audited by or on behalf of a licensing entity to determine whether the purported license is a valid license. The protected work may take the form of a protected audio work included within an audio component of a composite media content item that further includes a video component. Publication of a protected work may be granted or denied, access to the protected work may be enabled or blocked, and/or a beneficiary of revenue generated from publication of the protected work may be redirected based on a result of the audit.

### CROSS-REFERENCE TO RELATED APPLICATION

The present application claims priority to U.S. Provisional Patent Application Ser. No. 61/648,907, titled LICENSING PROTECTED WORKS WITHIN ELECTRONIC INFORMATION NETWORKS, filed May 18, 2012, the entire contents of which are incorporated herein by reference in their entirety for all purposes.

### FIELD

The disclosed subject matter relates in general to the field of licensing protected works within electronic information networks, and more particularly to the use of a license identifier to audit license information associated with protected works.

### BACKGROUND

Electronic media content in the form of digital audio, video, or image content pervades electronic information networks such as the Internet. Some access control techniques rely on encryption of electronic media content that is decrypted during playback through application of a key. Such keys may accompany financial transactions between consumers of electronic media content and content owners, creators, or licensing agents. Other access control techniques rely on the use of the “take down notice” in which a content owner, creator, or licensing agent informs a media host that unauthorized content is currently accessible at the media host and such access should be removed or blocked. Media hosts may be obligated to remove or otherwise block electronic media content responsive to these take down notices.

### SUMMARY

License information, including a license identifier (if present) is associated with a protected work that is published within an electronic information network. The license information indicates a purported license to publish the protected work. The license information may be audited by or on behalf of a licensing entity to determine whether the purported license is a valid license. The protected work may take the form of a protected audio work included within an audio component of a composite media content item that further includes a video component. Publication of a protected work may be granted or denied, access to the protected work may be enabled or blocked, or a beneficiary of revenue generated from publication of the protected work may be redirected based on a result of the audit.

This Summary presents only a small selection of the various concepts described in further detail by the Detailed Description and associated drawings, and is not intended to be used to limit the scope of the claimed subject matter.

### BRIEF DESCRIPTION OF DRAWINGS

FIG. 1 is a schematic diagram depicting an example electronic information network.

FIG. 2 is a flow diagram depicting an example method of licensing a protected work within an electronic information network.

FIG. 3 is a flow diagram depicting an example method of managing a license for a protected audio work.

FIG. 4 is a flow diagram depicting an example method of managing publication and/or access to a media content item.

FIG. 5 is a flow diagram depicting an example method of auditing license information.

FIG. 6 is a schematic diagram depicting an example computing system.

FIG. 7 is a schematic diagram depicting an example database system.

FIG. 8 is a schematic diagram depicting an example graphical user interface.

FIG. 9 is a schematic diagram depicting another example graphical user interface.

FIG. 10 is a flow diagram depicting an example workflow for assessing validity of a license for a protected work.

### DETAILED DESCRIPTION

Within electronic information networks, a variety of different entities may take part in the licensing, delivery, and consumption of electronic media content. FIG. 1 is a schematic diagram depicting an example electronic information network 100 that includes consumers of media content depicted as clients 150, license manager 120, media host 130, license auditor 140, and authorized license reseller 160. These various entities may communicate with each other over a communications network such as the Internet.

Within electronic information network 100, clients 150 may post media content to media host 130 and/or access media content from media host 130 over communications network 110. As an illustrative example, a user may share a media content item such as an image, a video, audio content, etc. with one or more other users by uploading the media content item from client 152 to media host 130 from which the other users may subsequently request and receive the media content item. A non-limiting example of a media host that is popular with today's users includes the YOUTUBE™ brand of media host, which enables users to upload and publish videos that are accessible to other users. Users may access media content from media hosts or directly from other users in a peer-to-peer connection by downloading or streaming the media content from a host computer to their respective client device over the communications network.

Licensing entities, such as license manager 120, authorized license reseller 160, or at times media host 130, that own and/or manage licenses to protected works may seek to limit or control access to the protected works. However, this desire to limit or control access may be, at times, in tension with the desire of consumers to share, access, and disseminate information. In one example scenario, a user may create a composite media content item that includes a video component and an audio component. The audio component may include a protected audio work, the rights of which may be owned, controlled, or otherwise retained by a third-party, such as a licensing entity. As one example, a user may have added a protected audio work in the form of a musical work to a video of a wedding or other event that was captured by that user. The user may have then uploaded that composite media content item to media host 130 for publication, enabling other users to access the composite media content item.

Under some current access control schemes, licensing entities that detect publication of a protected work that is perceived to be unauthorized may send what is referred to as a “take down notice” to the media host that informs the media host to discontinue publication of and/or block access to the protected work. However, this access control strategy may give rise to a number of issues. As one example, media content items that are published by a user at a media host may be erroneously blocked even if those media content items do not in-fact include the protected work. Erroneous blocking of media content items may also occur even if the user has properly obtained authorization to publish the protected work at the media host. These issues may be exacerbated by a number of factors, including the high volume and on-going nature of media publication, and the large quantity of protected works, users, and media hosts with which licensing entities must contend.

In at least some scenarios, some or all of these issues may be resolved, in whole or in part, by the issuance and association of license identifiers that indicate licenses for protected works with the publication of media content items that contain the protected works. Within electronic information networks, a license may be indicated by a license identifier. The license identifier may enable media content items that are published to network accessible locations to be audited for compliance with the terms of the license.

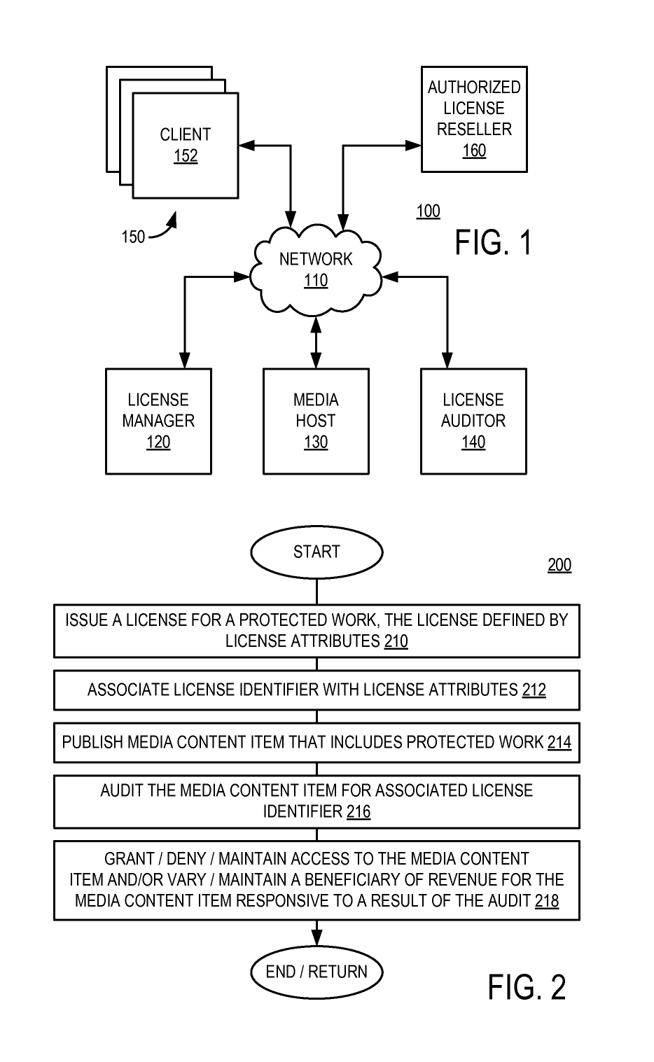

FIG. 2 is a flow diagram depicting an example method 200 of licensing a protected work within an electronic information network. It will be understood that FIG. 1 depicts a non-limiting example of an electronic information network. Accordingly, one or more of license manager 120, media host 130, license auditor 140, clients 150, and authorized license reseller 160 may form a common entity and/or a different combination of entities in other examples. Aspects of method 200 may be at times, performed by one, two, three, or more of the entities of FIG. 1.

Referring to FIG. 2, a license for a protected work may be issued by a licensing entity at 210. A licensing entity may take a variety of different forms, and may include one or more of license manager 120, authorized license reseller 150, and/or media host 130 of FIG. 1, depending on the particular implementation. A license may be defined one or more license attributes indicating who, what, when, where, and/or how a protected work may be used. The term “protected work” as used herein may refer to works that are protected by the copyright laws of the United States and/or foreign jurisdictions, or may refer to works over which a licensing entity desires to maintain control even if such works are not necessarily protected by copyright laws.

At 212, a license identifier indicating or otherwise enabling identification of the license may be associated with license attributes that define the license, including a content identifier that identifies the media content item for which the license has been issued. The license identifier may include a unique identifier (e.g., at least within a particular domain or use-environment) that enables two or more licenses to be distinguished from each other on the basis of their respective license identifiers. The license identifier may refer to the license and/or the license attributes stored in a database system, and may take a variety of different forms. As one example, a license identifier may include a text string formed from one or more text characters (e.g., alphabetic and/or numeric characters). A non-limiting example of a license identifier is: “6CT7ET1-ANETBIG-5JIL8GO-DBMDSW0-OYBN”. However, other suitable license identifiers having different characteristics may be used. The license identifier that includes a text string may be referred to as a “license key” in some implementations. As another example, the license identifier may itself define the license. For example, the license identifier may include one or more of the license attributes indicating who, what, when, where, and how the protected work may be used.

The licensing entity may provide the license identifier and/or license attributes defining the license to one or more other entities, such as a user of client 152, an agent of media host 130, an agent of license auditor 140, an agent of authorized license reseller 150, etc., depending on the particular implementation. In one example, a user may obtain a license to post a protected work at a media host that is accessible by one or more other users. In another example, the user may obtain the license directly from the license manager or from an authorized license reseller, or the license may be obtained on behalf of the user by another entity such as the media host at which the user seeks to publish the protected work.

At 214, the media content item including the protected work may be published at a network location that is accessible to other users. The network location may be controlled or operated by a media host, or may include a client device in a peer-to-peer network. Publication of the media content item may be accompanied by publication of the license identifier. The license identifier may be published in the same manner as the media content item in one example, or may be published through a different channel of publication such as a programming interface of the media host.

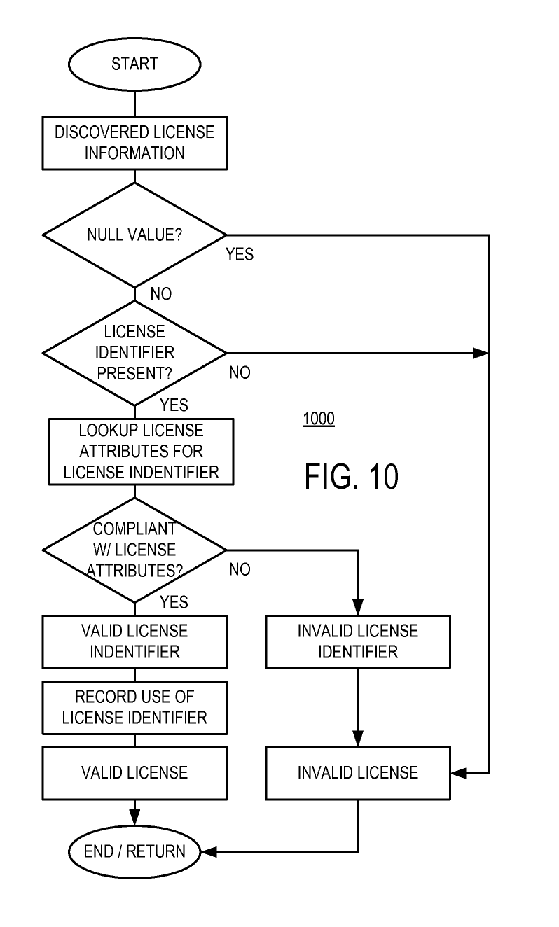

At 216, the media content item may be audited by an auditing entity for the presence of a valid license identifier within discovered license information that is associated with the media content item. The discovered license information may include the license identifier (e.g., in the case of a valid license), or may include a null value or an invalid license identifier. An example workflow for assessing the validity of a license and/or a license identifier is described in greater detail with reference to FIG. 10. The auditing entity may include one or more of license auditor 140, license manager 120, authorized license reseller 160, and/or media host 130. Access to the media content item may be granted, denied, or maintained by the media host at 218 responsive to the result of the audit. Alternatively or additionally, at 218, a beneficiary of revenue generated from publication of the media content item may be redirected or maintained responsive to the result of the audit.

Interactions between the various entities of FIG. 1 in carrying out method 200 of FIG. 2 will be described in greater detail by the following disclosure and associated drawings. As a non-limiting example, method 200 may be implemented through interactions between two, three, four, five, six or more different entities. In the context of FIG. 1, for example, authorized license reseller 160 may issue a license for a protected work to client 152 by providing a license identifier that indicates the license to the client. Authorized license reseller 160 may inform license manager 120 of the issued license by sharing license attributes defining the license and/or the license identifier with the license manager. Client 152 may upload a media content item that includes the protected work and the license identifier to media host 130 for publication to other clients 150. License auditor 140 may crawl media host 130 to discover protected works and license information that is associated with the protected works, including license identifiers (if present). License auditor 140 may reference license manager 120 for the issued license based on the license identifier discovered by the license auditor and/or may inform the license manager of the discovered license information, including the presence of a null value or an invalid license identifier. License manager 120 and/or license auditor 140 may inform media host 130 whether the protected work uploaded by client 152 complies with or will comply with the license that was issued to client 152.

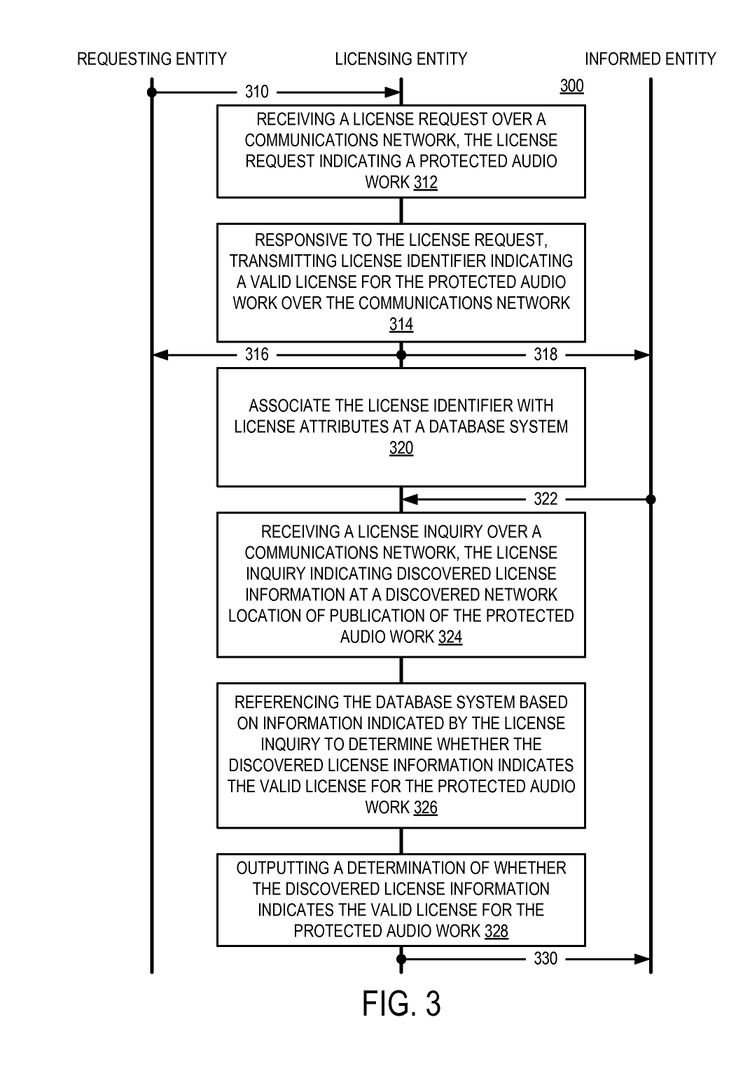

FIG. 3 is a flow diagram depicting an example method 300 of managing a license for a protected audio work. As a non-limiting example, method 300 may be performed by a licensing entity, such as a license manager, an authorized license reseller, or at times, a media host. A licensing entity may issue licenses for protected works to requesting entities, and may associate license attributes and a license identifier with the protected works in a database system controlled or operated by the licensing entity and/or an informed entity by application of method 300.

At 312, the method may include receiving a license request over a communications network. The license request may be initiated by and received from a requesting entity as indicated at 310. The requesting entity may include a client device in one example. In another example, the requesting entity may include an authorized license reseller or a media host acting as an authorized license reseller.

The license request may indicate a protected audio work for which a license is to be issued. In at least some implementations, protected audio works or the media content items that includes the protected audio works may be indicated by respective content identifiers, or may be inferred from context. A content identifier may include a unique identifier (e.g., at least within a particular domain or use-environment) that enables two or more media content items and/or protected works contained within the media content items to be distinguished from each other on the basis of their respective content identifiers.

In at least some implementations, the license request may be received as one or more programming interface calls via a programming interface. The one or more programming interface calls may include the content identifier of the protected audio work or media content item, a user account identifier for a user account attributed to the request, an identifier of a target network location of publication of the protected audio work, or other suitable information, including one or more desired or requested license attributes. In at least some implementations, the license request may be received as a purchase confirmation from a client device via an interactive online marketplace for the protected audio work. For example, a license manager, authorized license reseller, or media host may operate or control an interactive online marketplace in which licenses for the protected audio work and/or copies of the protected audio work may be purchased by consumers.

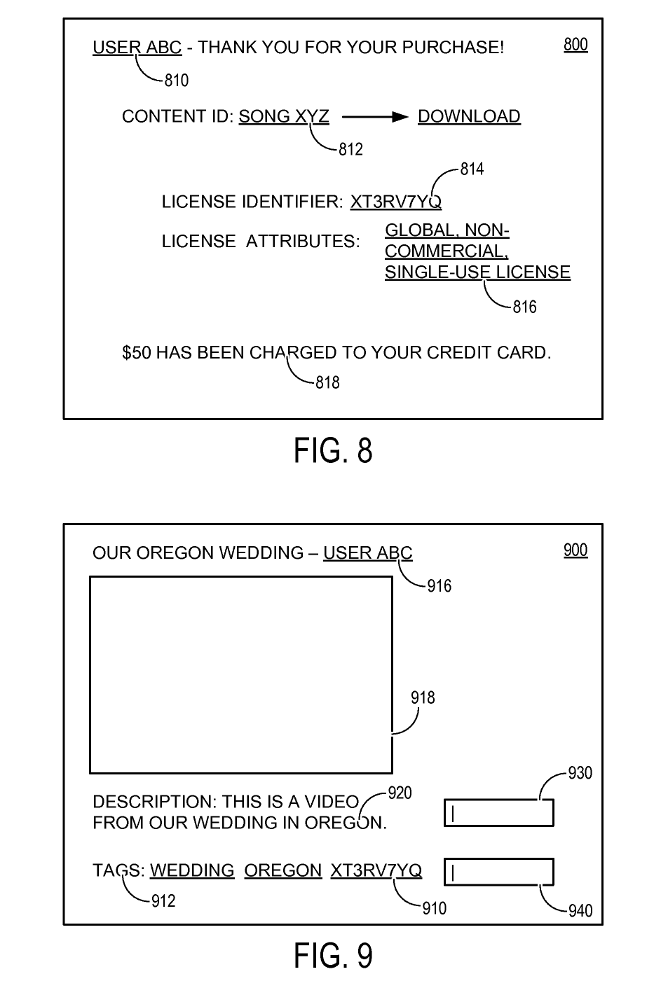

At 314, the method may include transmitting a license identifier indicating a valid license for the protected audio work over the communications network. The license identifier may be transmitted responsive to the license request, and may be accompanied by the license attributes defining the license. As one example, the license identifier may be transmitted to the requesting entity as indicated at 316. The license identifier and/or license attributes may be additionally or alternatively transmitted to an informed entity responsive to the license request, as indicated at 318. An informed entity may include a license manager, authorized license reseller, license auditor, or media host. As one example, if the license request was initially received at an authorized license reseller or a media host acting as an authorized license reseller, then the license identifier may be transmitted to a license manager to indicate issuance of the license. In the context of an interactive online marketplace, a media content item including the protected audio work may be transmitted along with the license identifier and/or license attributes to the requesting entity via the interactive online marketplace. A non-limiting example of this implementation is described in greater detail with respect to FIG. 8.

In at least some implementations, a license request and/or response to the license request may be received and/or issued via a programming interface. As one example, the license request may be received as one or more programming interface calls and/or the license information may be transmitted to the requesting entity and/or informed entity by issuing one or more programming interface responses via the programming interface. The one or more programming interface responses may include the license identifier, license attributes, media content item including the protected work, and/or other suitable information.

At 320, the method may include associating the license identifier at a database system with the license attributes, such as a content identifier of the protected audio work, a user account identifier of a user account attributed to the license request, an identifier of a target network location for publication of the protected audio work, and/or other suitable information. The database system may be operated or controlled by the licensing entity that responded to the license request, by the informed entity, or may be distributed or shared between the licensing entity and the informed entity.

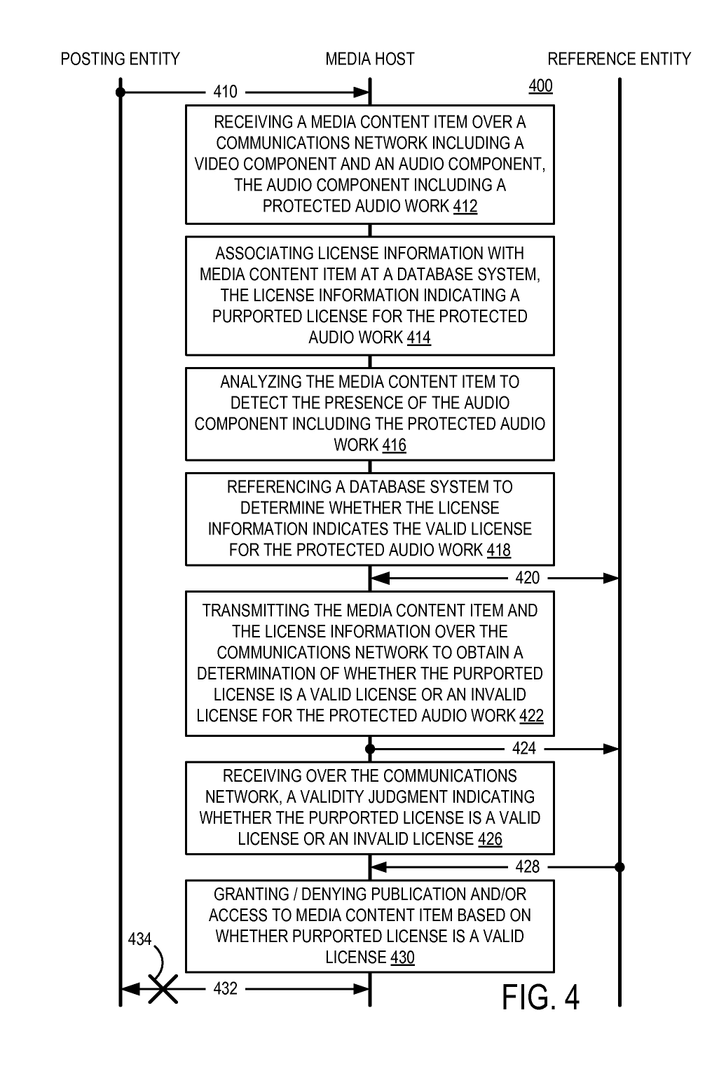

As will be described in further detail with respect to method 400 of FIG. 4, a protected work may be published to a network location that is accessible by one or more client devices. The network location may take the form of a server device or server system that is controlled or operated by a media host. The network location may alternatively take the form of a client device that enables other client devices to access the protected work over a peer-to-peer connection. An auditing entity may, from time-to-time, examine media content that is published at the network location. The auditing entity may discover protected works and/or license information published at the network location. The auditing entity may issue license inquiries to licensing entities to assess whether the protected work is licensed and/or whether the discovered license information indicates a valid license.

For example, at 322, a license inquiry may be initiated by an auditing entity. At 324, the method may include receiving the license inquiry from the auditing entity over a communications network. The license inquiry may indicate or include discovered license information at a discovered network location of publication of the protected audio work. The discovered license information may include the license identifier, or may include a null value or an invalid license identifier. The license inquiry may further indicate other suitable information, such as the discovered network location of publication of the protected audio work, a user account attributed to publication of the protected audio work, and/or other suitable information.

At 326, the method may include referencing the database system based, at least in part, on the information indicated by the license inquiry to determine whether the discovered license information indicates a valid license for the protected audio work. As one example, if the discovered license information includes a license identifier, and the license identifier is still valid (e.g., has not been exhausted through one or more prior uses), then the discovered license information may indicate a valid license. However, if the discovered license information includes a null value (e.g., lack of the license identifier) or an invalid license identifier (e.g., does not correspond to a valid license identifier in a queried database or corresponds to a license identifier that has been exhausted through one or more prior uses) then the discovered license information instead indicates an invalid license.

If the discovered license information indicates a valid license, the database system may be updated to indicate a use of the valid license (and a use of the license identifier) within a domain or subdomain of the network location of publication. A valid license may include a limited number of uses within an individual domain/subdomain or across a range of domains/subdomains in at least some implementations. For example, the discovered license information may be determined to not indicate a valid license if the valid license includes no remaining uses of the limited number of uses. As another example, the discovered license information may be determined to not indicate a valid license if the discovered network location for publication does not match the discovered network location of publication and/or if the user account attributed to publication of the protected audio work does not match the user account attributed to the license request received at 312. These and other license attributes will be described in greater detail with reference to FIG. 10.

At 328, the method may include outputting a determination of whether the discovered license information indicates a valid license for the protected audio work. The determination may be transmitted to an informed entity in at least some implementations. As one example, the determination may be output by transmitting a response to the license inquiry to an auditing entity over the communications network as indicated at 330. The response may include the determination of whether the discovered license information indicates the valid license. As another example, determination may be output by transmitting a notice to an agent of the discovered network location over the communications network, again as indicated at 330. The notice may indicate the protected audio work (e.g., a content identifier), a user account attributed to the license request (e.g., a user account identifier), a user account attributed to publication of the protected work (e.g., a user account identifier), and/or a determination of whether the discovered license information indicates a valid license, among other suitable information.

In at least some implementations, a license inquiry and/or a determination of whether the discovered license information is valid may be received and/or issued via a programming interface. As one example, the license inquiry may be received as one or more programming interface calls and/or the determination may be transmitted by issuing one or more programming interface responses via the programming interface.

FIG. 4 is a flow diagram depicting an example method 400 of managing publication and/or access to a media content item. As a non-limiting example, method 400 may be performed by a media host or other suitable entity controlling or operating a network accessible location. Media content items containing protected works that are published at a network accessible location may be discovered by the media host and/or through assistance of a reference entity, and discovered license information associated with the protected works (including license indicators if present) may be audited by the media host and/or through assistance of a reference entity for compliance with licenses issued for those protected works by application of method 400.

At 412, the method may include receiving a media content item over a communications network from a posting entity. The media content item may be transmitted by a posting entity as indicated at 410. The posting entity may include a client device operated by a consumer or purchaser of a protected audio work or a license thereto, a license manager, an authorized license reseller, or other suitable entity.

As one example, the media content item received at 412 may include a video component and an audio component. The audio component may include a protected audio work. Non-limiting examples of composite media content items that include both video and audio components include MPEG, WMV, On2 encoded files to name just a few examples. It will be understood that a media content item may have any suitable format and may be encoded using any suitable codec technology. In at least some implementations, the media content item may be received via a programming interface, such as via one or more programming interface calls or post messages used to upload the media content item to the media host.

In at least some implementations, the method at 412 may further include receiving license information (including a license identifier if present) from the posting entity over the communications network. The license information (including the license identifier if present) may indicate a purported license for the protected audio work. The purported license may be a valid license or an invalid license. In some examples, the license identifier or other license information may take the form of a user applied information tag as will be described in further detail with respect to FIG. 9. The licensing information (including a license identifier if present) and the media content item may be received together in some examples, or may form part of one or more related programming interface calls or post messages initiated by the posting entity that are received by the media host via a programming interface. The one or more programming interface calls or post messages may include a content identifier of the protected audio work and a user account identifier of a user account attributed to the posting entity, in some examples.

At 414, the method may include associating the license information (including a license identifier if present) with the media content item at a database system. The database system may be operated or controlled by the media host, by a reference entity, or may be distributed or shared between the media host and the reference entity. The reference entity of FIG. 4 may refer to the previously described licensing entity or informed entity of FIG. 3. The license information (including a license identifier if present) may be associated with the media content item by adding the license information to an electronic media file (e.g., the electronic media file forming the media content item) as metadata. As another example, the license information (including a license identifier if present) may be associated with the media content item by associating the license information with a media content identifier in a database system that identifies the media content item.

In at least some implementations, an interactive online marketplace may be provided for the protected audio work and/or a license to the protected audio work. The interactive online marketplace may accessible be to consumers over a communications network. A financial transaction may be facilitated via the interactive online marketplace with a consumer via a client device for a valid license for the protected audio work. The license identifier may be associated with the media content item responsive, for example, to the financial transaction in order to indicate the valid license for the protected audio work.

In at least some implementations, the media host, at 416, may analyze the media content item to detect the presence of the audio component that includes the protected audio work. As one example, the presence of the audio component may be detected based, at least in part, on a comparison of the audio component to a database of audio fingerprints. However, in another implementation, the media host may not take part in analyzing media content items for protected audio works.

At 418, the media host may reference a database system to determine whether the discovered license information (including a license identifier if present) indicates a valid license for the protected audio work. The database system may be controlled or operated by the media host in one example. In another example, the database system may be controlled or operated by a reference entity. In either example, the media host may send requests to and receive responses from the database system to determine if the discovered license identifier indicates a valid license. In at least some implementations, the database system may be referenced via a programming interface by one or more programming interface calls. An example request and response from a database system is indicated at 420, in which the media host references a database system operated or controlled by a reference entity, such as a license manager or license auditor.

In at least some implementations, the method at 422 may include transmitting the media content item and/or the license information (including a license identifier if present) over the communications network to a reference entity to be audited. If the license information includes a null value, the method at 422 may include transmitting an indication of the null value. The reference entity may again include a license manager, license auditor, or authorized license reseller. The license information (including a license identifier if present) may enable the reference entity to determine if the purported license is a valid license or an invalid license for the protected audio work. The transmitted media content item and/or license information (including a license identifier if present) is indicated schematically at 424. Communications indicated at 424 may take the form of one or more programming interface calls and responses via a programming interface provided by the media host or the reference entity.

At 426, the method may include receiving a validity judgment over the communications network indicating whether the purported license is a valid license or an invalid license. The validity judgment may be transmitted by and received from the reference entity as indicated at 428. The validity judgment may be generated based, at least in part, on a comparison between the discovered license information indicating a purported license and the valid license for the protected audio work using, for example, the license identifier. If the discovered license information takes the form of a null value or if the discovered license information does not include a license identifier, then the validity judgment may indicate an invalid license. If a license identifier is present within the discovered license information, the validity judgment may indicate a valid or invalid license depending on whether publication of the protected work was in compliance with the license attributes. The validity judgment may take the form of a “take down notice” in some examples.

At 430, the method may include granting or denying publication of and/or access to the media content item based at least in part on whether the purported license is a valid license. If the purported license is determined to be a valid license, then the method at 430 may include publishing the media content item to a network location and/or granting one or more other client devices access to the media content item at the network location. The network location may be accessible to one or more other client devices over the communications network as indicated at 432. If the purported license is determined to not be a valid license for the protected audio work, then at 430, the method may include denying publication of the media content item to the network location and/or denying the one or more other client devices access to the media content item at the network location as indicated at 434. As another example, if the purported license is not a valid license for the protected audio work, then the method at 430 may alternatively or additionally include publishing the media content item to a network location accessible to one or more other client devices and/or granting the one or more other client devices access to the media content item at the network location, and varying a beneficiary of revenue generated from advertisements presented with the media content item. Hence, rather than denying access to a protected work, revenue (e.g., advertising or subscription revenue) derived from publication of that protected work may be redirected to a licensing entity such as a license manager or an authorized license reseller, for example.

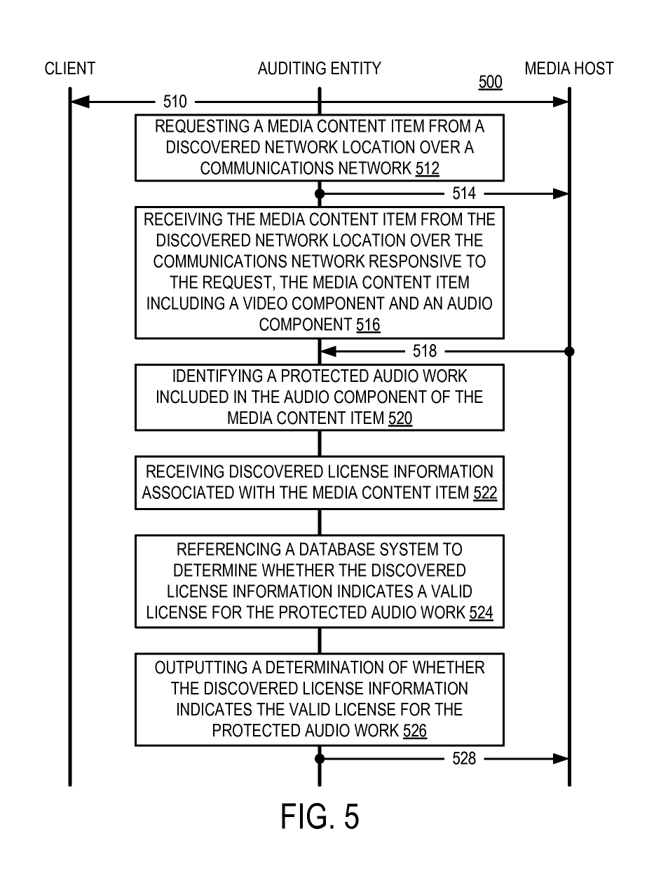

FIG. 5 is a flow diagram depicting an example method 500 of auditing license information for the presence of a valid license identifier indicating a valid license. As a non-limiting example, method 500 may be performed by an auditing entity, such as a license manager, license auditor, authorized license reseller, or media host. Media content items containing protected works that are published at a network accessible location may be discovered, and license information associated with the protected works may be audited for compliance with licenses issued for those protected works by application of method 500.

At 512, the method may include requesting a media content item from a discovered network location over a communications network. An example request for the media content item is indicated at 514. The discovered network location may take the form of a public network location of a media host where the media content item is published, enabling access to the media content item by one or more client devices as indicated at 510. For example, these client devices may request and receive the media content item from the discovered network location over the communications network. The auditing entity may, in at least some examples, request the media content item from the discovered network location by requesting the media content item using the same protocol as the client devices. In another example, the auditing entity may request the media content item using a different request protocol than the client devices or via different channel of communication, such as via a special purpose programming interface of the media host that is made available for the auditing entity.

At 516, the method may include receiving the media content item from the discovered network location over the communications network responsive to the request. The media content item may, as a non-limiting example, include a video component and an audio component. An example response from the discovered network location that includes the media content item is indicated at 518. The response received at 518 may take the form of a downloaded electronic file representing the media content item or the media content item may be streamed from the media host using any suitable response protocol. In one example, the auditing entity may receive the media content item from the discovered network location in the same form as received by the client devices. In another example, the auditing entity may receive the media content item in a different form as received by the client devices, such as via a special purpose programming interface of the media host that is made available for the auditing entity.

At 520, the method may include identifying a protected audio work included in the audio component of the media content item. As one example, the protected audio work may be identified by analyzing the media content item to detect the presence of the audio component including the protected audio work based, at least in part, on a comparison of the audio component to a database of audio fingerprints. However, it will be understood that other suitable techniques may be used to identify protected audio works within composite media content items.

At 522, the method may include receiving discovered license information associated with the media content item from the discovered network location over the communications network. Discovered license information may take the form of a value (e.g., a valid or invalid license identifier) or a null value (e.g., the absence of a license identifier where a license identifier would be otherwise expected to reside for a valid license). In some examples, the discovered license information may be associated with the media content item as metadata of the media content item and/or may be published at the discovered network location with or alongside the media content item. Accordingly, the license information received at 522 may form part of the media content item received at 516, 518. As another example, the license information may be presented as user readable information via a user interface (e.g., of a browser program or viewer program displayed at a client device) alongside a visual component of the media content item. A non-limiting example of a user interface is described in further detail with reference to FIG. 9. As yet another example, the license information may form part of computer readable instructions received from the discovered network location, such as HTML, or other suitable instruction set, that is transmitted by the media host responsive to the request at 512, 514. In at least some implementations, the license information may be received via a special purpose programming interface of the media host that is made available for the auditing entity to request and receive license information.

Other suitable information may be obtained from the media host by the auditing entity. Such information may include an identifier of the media content item, an identifier of a user account attributed to posting or publication of the media content item at the media host, a date of posting and/or publication of the media content item at the media host, a number of times the published media content item has been accessed at the media host, etc. This information may be received by the auditing entity via a programming interface of the media host in the form of one or more programming interface responses.

At 524, the method may include referencing a database system to determine whether the discovered license information indicates a valid license for the protected audio work. The database system may be controlled or operated by the auditing entity in some examples. In other examples, the auditing entity may reference a database system controlled or operated by a reference entity such as previously described with respect to method 300 of FIG. 3. An example workflow for assessing the validity of a license and/or a license identifier is described in greater detail with reference to FIG. 10.

At 526, the method may include outputting a determination of whether the discovered license information indicates the valid license for the protected audio work. As one example, the determination may be output by transmitting a validity judgment to an agent of the discovered network location (e.g., media host) as indicated at 528 over a communications network. The determination may take the form of a programming interface call that is received at the media host via a programming interface. The determination may be alternatively or additionally transmitted to a license manager or authorized license reseller. The validity judgment may indicate whether the discovered license information indicates the valid license, and may include other suitable information such as the identifier of the media content item, an identifier of a user account attributed to posting the media content item at the media host, a date of posting and/or publication of the media content item at the media host, a number of times the published media content item has been accessed at the media host, etc.

The determination received by the media host at 528 may be used by the media host to take an action with respect to the publication of the media content item. For example, as previously described with respect to processes 430, 432 of FIG. 4, the media host may grant or deny publication of the media content item, access to the protected work by client devices may be enabled or blocked, or a beneficiary of revenue generated from publication of the protected work may be redirected to a licensing entity based on a result of the determination.

In at least some implementations, the disclosed methods, processes, and techniques may be performed by one or more computing devices. For example, these methods, processes, and techniques may be implemented as computer-readable instructions that are executed or executable by one or more computing devices. These instructions may take the form of an operating system or portion thereof, one or more application programs, and/or firmware, among other suitable instruction sets. These instructions may reside at and be executed by an individual computing device, or may be distributed across two or more computing devices to provide the same or different functionality at the two or more computing devices.

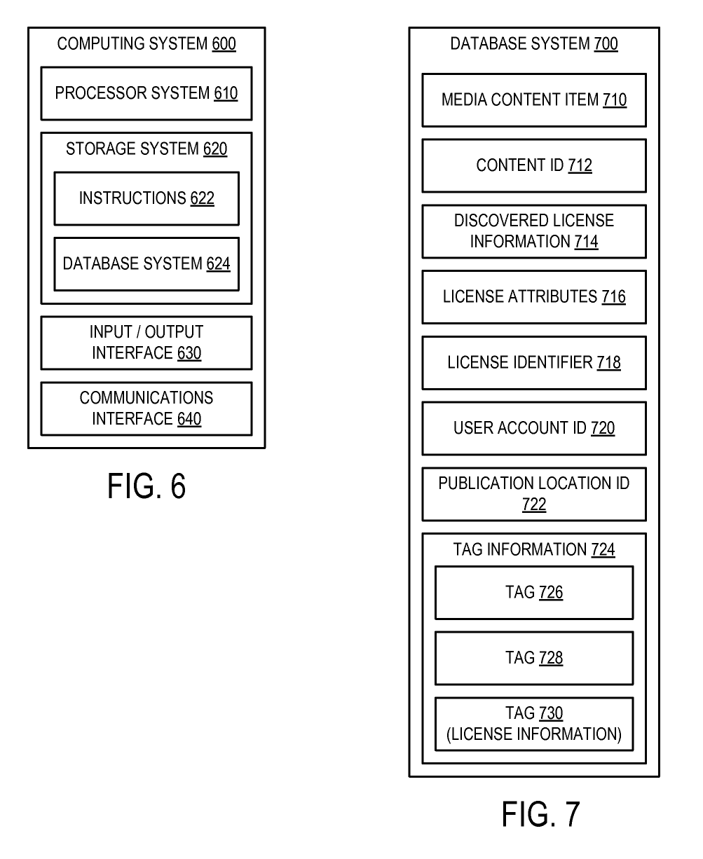

FIG. 6 is a schematic diagram depicting an example computing system 600. Computing system 200 may correspond to one or more of the computing devices controlled or operated by one or more of the previously described license manager 120, media host 130, license auditor 140, client 150, or authorized license reseller 160 of FIG. 1. Computing system 600 may take the form of one or more personal computers, desktop computers, laptop computers, handheld computers, mobile computing devices, smart phones, tablet computers, electronic gaming devices, server devices, and/or other suitable electronic devices.

Computing system 600 may include one or more processors forming a processor system 610, one or more storage devices forming a storage system 620, an input/output interface 630, and a communications interface 640. Storage system 620 may include one or more physical, non-transitory, devices configured to hold or otherwise store data and/or instructions 622 executable by one or more processors of processor system 610 to implement the herein described methods and/or processes. Data may be held or otherwise stored in a database system 624 of storage system 620. When such methods and/or processes are implemented, a state of storage system 620 may be changed or transformed, for example, to hold different data and/or instructions. Instructions 622 may include or take the form of an operating system, software application, firmware, plug-in, or other suitable instruction set.

Input/output interface 630 may include or may be configured to interact with one or more input devices and/or one or more output devices to enable a human operator (e.g., a user) to interact with computing system 600. Non-limiting examples of input devices may include a pointing device such as a mouse, joystick, controller, etc., a text input device such as a keyboard, keypad, etc., a touch-screen display, a touch pad, a microphone, or other suitable input device. Non-limiting examples of output devices may include a graphical display such as a monitor, television, or touch-screen display, an audio speaker, a printer, or other suitable output device.

Communications interface 640 may support wired and/or wireless communications with one or more other computing devices and/or systems using any suitable communications protocol. Non-limiting example communications protocols include Internet protocols, 3G or 4G wireless protocols, wide area network protocols, local area network protocols, and/or personal area network protocols to name just a few examples. Communications interface 640 may support communications with previously described communications network 110 of FIG. 1. Accordingly, communications network 110 may include one or more of a wide area network (WAN) (e.g., the Internet), local area network (LAN) (e.g., an intranet), and/or a personal area network (PAN) that supports wired and/or wireless forms of communication.

FIG. 7 is a schematic diagram depicting an example database system 700. Database system 700 is a non-limiting example of previously described database system 624 of FIG. 6. Database system 700 may reside at a single computing device or may be distributed across two or more computing devices that are controlled or operated by one or more entities.

Database system 700 includes an association of multiple data items, including a media content item 710, a content identifier 712 that identifies the media content item or protected work within the media content item, discovered license information 714, license attributes 716 defining a license for the protected work, a license identifier 718 indicating a license defined by license attributes 716, a user account identifier 720 indicating a user account attributed to publication of the protected work and/or a user account attributed to a license request for the protected work, a publication location identifier 722 identifying a network location (e.g., domain/subdomain) where the protected work was published, and tag information 724. As will be described in greater detail with respect to FIG. 9, a user may apply information tags to media content. Example information tags include tag 726, tag 728, and tag 730. Tag 730 takes the form of discovered license information (that may or may not include a license identifier) that has been applied by a user. User account identifier 718 may take the form of or be indicated by an information token, a username, a password, a domain unique identifier, a combination thereof, or others suitable value that enables two or more users to be distinguished from each other globally or within the context of a particular domain or use-environment.

It will be understood that database system 700 may include additional data items or fewer data items than depicted in FIG. 7, depending on the context. For example, a database system of a licensing entity may include additional information relating to licenses, and may omit tag information 724. A database system of a media host, for example, may include tag information 724 as applied by one or more users, and may optionally omit user account identifier 720.

FIG. 8 is a schematic diagram depicting an example graphical user interface (GUI) 800. GUI 800 may be presented to a user via a graphical display of a client device as part of an interaction with an interactive online marketplace for protected works. GUI 800 in this example indicates a user identifier such as “USER ABC” at 810, a content identifier indicating the protected work (e.g., “SONG XYZ”) at 812, a license identifier taking the form of a text string “XT3RV7YQ” at 814, license attributes (e.g., “Global, Non-Commercial, Single-Use License”) at 816, and a financial transaction description at 818 indicating that an amount of “$50” has been charged to the user's “credit card account” in exchange for issuing a license to the user for the protected work.

FIG. 9 is a schematic diagram depicting another example GUI 900. GUI 900 provides an example interface for a user to associate license information (including a license identifier if present) with a media content item at a media host. GUI 900 may be presented to all or some of the users (e.g., clients) of the media host in some examples, to enable those users to access media content items that are posted by another user. Accordingly, GUI 900 provides a non-limiting example of publication of a media content item at a network location by a media host. GUI 900 may present a user account identifier 916 (e.g., “USER ABC”) for the user that has posted the media content item to the media host, a viewing region 918 for presentation of a video component of the media content item, a description 920 of the media content item, and tag information 912. Users may apply tag information to a media content item to describe and enable searching or organization of the media content item within an information network.

In some examples, GUI 900 may include a special purpose text field 930 for receiving license information (including a license identifier if present) from a user. License information that is submitted via text field 930 may be associated with a media content item to indicate a purported license for a protected work contained within that media content item. If no license information is submitted via text field 930, then the license information may take the form of a null value. The license information submitted via text field 930 may or may not be presented to users in a human readable format. As one example, the license information submitted via the special purpose text field 930 may be associated with the media content item within a database system without publishing the license information in a manner that is accessible to other users of the media host. In this implementation, auditing entities may obtain the license information (including a license indicator if present) from the media host via a programming interface or other dedicated channel. In other examples, the license information (including license indicator if present) may be published by the media host in a manner that is accessible to other users of the media host. For example, the license identifier may take the form of a text string that is presented at 910 in a human readable format or alternatively within computer-readable information that is transmitted to the clients with GUI 900 (e.g., as webpage markup language).

In other examples, GUI 900 may include a multi-purpose text field 940 for receiving both tag information and a license information (including a license indicator if present) from a user. A license identifier that is submitted via text field 940 may also be associated with a media content item to indicate a purported license for a protected work contained within that media content item. For example, GUI 900 depicts example tag information at 912 that also includes descriptive tags “wedding” and “Oregon” that further describe attributes of the media content item. Tag information 912 additionally includes a license identifier in the form of a text string that is presented at 910 in a human readable format. If no license information is submitted via text field 940, then the license information may take the form of a null value. In implementations where the license information is published by the media host in a manner that is accessible to other users, auditing entities may obtain the license information (including the license indicator if present) by requesting and analyzing (e.g., crawling) GUI 900 or links within GUI 900 to identify license identifier 910. As one example, license identifier 910 may be parsed from other tag information (e.g., “wedding” and “Oregon”) that does not contain the license identifier.

As previously discussed, a license may be defined by one or more license attributes indicating who, what, when, where, and/or how a protected work may be used. Non-limiting examples of license attributes include: (1) a Content Identifier attribute that identifies the protected work or a portion thereof; (2) a User Account attribute that identifies the entity attributed to the license request; (3) a Term attribute that identifies one or more of a start date and/or time, end date and/or time, and/or a period of time that the protected work may be published; (4) a Region attribute that identifies one or more geographic regions and/or IP address value ranges from which client devices may access the protected work and/or to which the protected work may be transmitted from the network location of publication; (5) a Network Location attribute that identifies one or more network domains and/or sub-domains where the protected work may be published; a (6) a Purpose attribute that identifies whether the protected work may be used commercially (e.g., to financially benefit the license holder or third-party) or non-commercially; (7) a Beneficiary attribute that identifies an entity that is to be the beneficiary of revenue generated from publication of the protected work; (8) a Number of License Uses attribute that identifies a maximum number of different network domains/sub-domains or network locations through which the protected work may be published; (9) a Number of Times Accessed attribute that identifies a maximum number of times that the protected work may be accessed by end users or other entities through one or more network domains/subdomains or network locations publishing the protected work; (10) an Exclusivity attribute that identifies whether the license to publish the protected work is exclusive to an individual user account or is non-exclusive enabling multiple licenses to be issued to multiple users to publish the protected work.

It will be understood that the above attributes are an example selection of attributes that may be used to define a license for a protected work. It will be appreciated that other suitable license attributes or combinations of license attributes may be used to define the scope of a license. A license identifier and one or more of these license attributes may be communicated between entities, such as clients, license managers, media hosts, license auditors, authorized license resellers, etc. via their respective computing devices, for example, as parameters of a programming interface call or post message, or other suitable form of communication. As one example, a first computing device may request a license from a second computing device by transmitting a programming interface call to the second computing device that indicates one or more desired attributes. As another example, a first computing device may inform a second computing device of a license by posting one or more attributes of the license to the second computing device, along with a corresponding license identifier.

FIG. 10 is a flow diagram depicting an example workflow 1000 for assessing validity of a license for a protected work. Discovered license information associated with publication of a protected work that takes the form of a null value may be identified as an invalid license. If a license identifier is not present in the discovered license information, then the discovered license information may be identified as an invalid license. If a license indicator is present in the discovered license information, then the license attributes indicated by the license identifier may be referenced to determine whether publication of the protected work is in compliance with the license attributes. If publication is not compliant with one or more license attributes, then the license identifier is considered an invalid license identifier and the license is judged invalid. If the publication is compliant with the license attributes, then the license identifier is considered to be a valid license identifier and the license is judged to be valid. A use of the license identifier may be recorded to maintain a compliance with limitations on the number of times a particular license indicator may be used.

The various configurations and/or techniques described herein are exemplary in nature. Disclosed implementations, embodiments, or examples are not to be considered in a limiting sense, because numerous variations are possible. The methods and/or processes described herein may represent one or more of any suitable number of processing strategies. The various methods and/or processes that have been described and/or depicted may be performed in the disclosed sequence, in other sequences, in parallel, or in some cases omitted. The subject matter of the present disclosure includes all novel and nonobvious combinations and subcombinations of the various configurations and techniques, and other features, functions, acts, and/or properties disclosed herein, as well as any and all equivalents thereof.

1. A method of managing a license for a protected audio work, the method comprising:
receiving a license request from a client device over a communications network, the license request indicating a protected audio work;
responsive to the license request, transmitting a license identifier indicating a valid license for the protected audio work to the client device over the communications network;
associating the license identifier with a user account attributed to the license request;
receiving a license inquiry from a license auditor over a communications network, the license inquiry indicating a user account attributed to publication of the protected work and including discovered license information at a discovered network location of publication of the protected audio work;
referencing the database system based, at least in part, on the user account attributed to publication of the protected work indicated by the license inquiry to determine whether the discovered license information indicates the valid license for the protected audio work; and
outputting a determination of whether the discovered license information indicates the valid license for the protected audio work.

2. The method of claim 1, wherein outputting the determination includes transmitting a response to the license inquiry to the license auditor over the communications network, the response including the determination of whether the discovered license information indicates the valid license.

3. The method of claim 1, wherein outputting the determination includes transmitting a notice to an agent of the discovered network location over the communications network, the notice indicating the protected audio work, the user account attributed to publication of the protected work, and the determination of whether the discovered license information indicates the valid license.

4. The method of claim 1, wherein receiving the license request includes receiving one or more programming interface calls via a programming interface, the one or more programming interface calls including an identifier of the protected audio work, an identifier of the user account attributed to publication of the protected work, and an identifier of a network location of publication of the protected audio work; and
wherein transmitting the license identifier includes issuing one or more programming interface responses via the programming interface, the one or more programming interface responses including the license identifier.

5. The method of claim 1, further comprising:
if the discovered license information indicates the valid license, updating the database system to indicate a use of the valid license, the valid license including a limited number of uses; and
determining that the discovered license information does not indicate the valid license if the valid license includes no remaining uses of the limited number of uses or if the discovered license information does not include the license identifier.

6. The method of claim 1, wherein receiving the license request includes receiving a purchase confirmation from the client device via an interactive online marketplace for the protected audio work; and
wherein the method further comprises:
transmitting a media content item including the protected audio work to the client device via the interactive online marketplace.

7. The method of claim 1, wherein the license request further indicates a target network location for publication of the protected audio work, and the license inquiry further indicates the discovered network location of publication of the protected audio work; and
wherein the method further comprises:
determining that the discovered license information does not indicate the valid license if the discovered network location for publication does not match the discovered network location of publication or if the discovered license information does not include the license identifier.

8. A storage system having instructions stored thereon executable by a processor system to:
receive a media content item over a communications network from a client device, the media content item including a video component and an audio component, the audio component including a protected audio work;
associate a license identifier with the media content item at a database system, the license identifier indicating a purported license for the protected audio work;
if the purported license is a valid license for the protected audio work as indicated by the license identifier associated with the media content item, publish the media content item to a network location accessible to one or more other client devices and/or granting the one or more other client devices access to the media content item at the network location; and
if the purported license is not a valid license for the protected audio work, deny publication of the media content item to the network location accessible to the one or more other client devices and/or deny the one or more other client devices access to the media content item at the network location.

9. The storage system of claim 8, wherein the license identifier is associated with the media content item by adding the license identifier to an electronic media file as metadata of the media content item.

10. The storage system of claim 8, wherein the license identifier is associated with the media content item by associating the license identifier with a media content identifier in a database system that identifies the media content item.

11. The storage system of claim 8, wherein the instructions are further executable by the processor system to:
receive the license identifier from the client device over the communications network, the license identifier forming a user applied information tag including a text string.

12. The storage system of claim 8, wherein the instructions are further executable by the processor system to:
provide an interactive online marketplace for the protected audio work accessible to the client device;
facilitate a financial transaction with the client device for the valid license for the protected audio work; and
responsive to the financial transaction, associate the license identifier with the media content item to indicate the valid license for the protected audio work.

13. The storage system of claim 8, wherein the instructions are further executable by the processor system to:
receive the licensing information and the media content item with one or more programming interface calls via a programming interface, the one or more programming interface calls including an identifier of the protected audio work and an identifier of a user account; and
associate the license identifier and the media content item with the identifier of the user account and the identifier of the protected audio work at the database system.

14. The storage system of claim 8, wherein the instructions are further executable by the processor system to:
analyze the media content item to detect the presence of the audio component including the protected audio work based, at least in part, on a comparison of the audio component to a database of audio fingerprints.

15. The storage system of claim 8, wherein the instructions are further executable by the processor system to:
transmit the media content item and the license identifier over the communications network to a license auditor, the license identifier enabling the license auditor to determine if the purported license is a valid license or an invalid license for the protected audio work;
receive over the communications network, a validity judgment indicating whether the purported license is a valid license or an invalid license, the validity judgment generated based, at least in part, on a comparison performed by the license auditor between the purported license and the valid license for the protected audio work using the license identifier.

16. The storage system of claim 8, wherein the instructions are further executable by the processor system to:
if the purported license is not a valid license for the protected audio work, then:
publish the media content item to a network location accessible to one or more other client devices and/or granting the one or more other client devices access to the media content item at the network location, and vary a beneficiary of revenue generated from advertisements presented with the media content item; or
deny publication of the media content item to the network location accessible to the one or more other client devices and/or deny the one or more other client devices access to the media content item at the network location.

17. The storage system of claim 8, wherein the instructions are further executable by the processor system to:
reference a database system to determine whether the license identifier indicates the valid license for the protected audio work, wherein the database system resides at a license manager and is referenced via a programming interface by one or more programming interface calls.

18. A method of auditing a license for a protected audio work, the method comprising:
requesting a media content item from a discovered network location over a communications network, the discovered network location publishing the media content item to one or more client devices;
receiving the media content item from the discovered network location over the communications network responsive to the request, the media content item including a video component and an audio component;
identifying a protected audio work included in the audio component of the media content item;
receiving discovered license information associated with the media content item from the discovered network location over the communications network;
referencing a database system to determine whether the discovered license information indicates a valid license for the protected audio work, wherein the discovered license information does not indicate a valid license if the discovered license information does not include a license identifier that indicates the valid license; and
outputting a determination of whether the discovered license information indicates the valid license for the protected audio work.

19. The method of claim 18, wherein the discovered license information is associated with the media content item as metadata of the media content item and/or is published at the discovered network location with the media content item.

20. The method of claim 18, wherein outputting the determination includes:
transmitting over the communications network to an agent of the discovered network location and/or to a license manager, a validity judgment indicating whether the discovered license information indicates the valid license.
